(19) United States
(12) Patent Application Publication
(10) Pub. No.: US 2016/0352456 A1
(43) Pub. Date: Dec. 1, 2016

(54) SIGNAL TO NOISE RATIO CONCEALMENT APPARATUS AND METHOD IN WIRELESS MULTIMEDIA SYSTEM

(71) Applicant: AIROHA TECHNOLOGY CORP., Hsinchu (TW)

(72) Inventors: WEN-SHENG HOU, HSINCHU (TW); CHIEN-CHEN LIN, HSINCHU (TW)

(21) Appl. No.: 14/721,066

(22) Filed: May 26, 2015

(51) Int. Cl. H04L 1/00; H04L 1/20

(52) U.S. Cl. CPC H04L 1/0036; H04L 1/20

(57) ABSTRACT

An apparatus and method for improved processing of audio and video in the wireless multimedia communication. By setting a SNR estimator in the de-modulator and connecting a PLC trigger between the de-modulator and the PLC module in parallel. The SNR estimator can calculate the signal to noise ratio (SNR) of the wireless signal in the de-modulator directly. The PLC trigger can calculate the losing condition of the digital signal and make the decision whether proceeds the packet loss concealment (PLC) depend on the condition to make the PLC to the highest efficiency.

### FIELD OF THE INVENTION

The present disclosure relates to an apparatus and method for improved processing of audio and video in the wireless multimedia communication.

### BACKGROUND

A network packet is a formatted unit of data carried by a packet-switched network. And in the conventional wireless packet networks, sometimes transmitted packets are erased or lost, called packet erasure or loss. This will make the communication quality poor. Generally, the spurious packets made by the packets lost, bit error and noise are the main reason of errors in digital communications.

In many multimedia communication systems, the packet loss concealment (PLC) logic is invoked at the decoder to try to conceal the quality-degrading effects of the lost packet or erasure, thereby avoiding substantial degradation in output quality, such as WIFI, Bluetooth use for audio and video device system.

There are two conventional concealment methods: transmitter based method and receiver based method. The transmitter based recovery techniques, for example, the forward error correction (FEC) is adding the error correction code to the packets transmitted. And another example, automatic repeat-request is an error-control method for data transmission using acknowledgements and timeouts to achieve reliable data transmission over an unreliable service. If the sender does not receive an acknowledgment before the timeout, it usually re-transmits the frame/packet until the sender receives an acknowledgment or exceeds a predefined number of re-transmissions.

The disadvantages of the above mentioned technologies are high power consumption and high bandwidth requirement. In poor signal conditions, they inherently lead to network congestion and delay.

In addition to transmitter-based recovery techniques, a method concealing any remaining degradation left after the transmitter-based recovery techniques can be employed. In the applications of voice, a parameter commonly chosen for interpolation and/or extrapolation is the pitch period. A waveform with a length of the estimated pitch period or a multiple of the estimated pitch period is generated as a substitute for the degraded packet.

And in video communications, the interpolation and/or extrapolation based techniques are commonly used. These techniques generate a replacement packet by interpolating the parameters from the packets on one or both sides (1D), pre-video line or post-video line (2D) or pre-video frame or post-video frame (3D) of the degraded packet.

Referring to FIG. 1 there is shown a schematic view of a concealment apparatus in wireless multimedia system in prior arts. The concealment apparatus in wireless multimedia system 100 includes a modulator 101, a de-modulator 103, an A/V-decoder 105, a PLC module 107 and a gain controller 109.

The modulator 101 can send a wireless signal, and the de-modulator 103 can receive the wireless signal and transform it into a digital signal. The A/V-decoder 105 can receive the digital signal and transform it into a multimedia signal. The PLC module 107 can receive the multimedia signal. If the multimedia signal is intact, the PLC module 107 will transport the multimedia signal to the gain controller 109.

And if the multimedia signal has defects and/or loss, the PLC module 107 can conceal the defects and/or loss packets depend on the information of the previous and/or following intact packets, and transport the concealed multimedia signal to the gain controller 109. The gain controller 109 can control the gain of the multimedia signal concealed. To achieve the purpose of concealing the defects and/or loss of the multimedia signal caused by wireless transportation and make the output audio and/or video more smooth and harmonious.

### SUMMARY OF THE INVENTION

It is a primary objective of the present invention to provide a signal to noise ratio concealment apparatus and method in wireless multimedia system. Because the damaged packets often contain information that can be used to improve the quality of the multimedia signal. An object of the present disclosure is to set a SNR estimator in the de-modulator and connect a PLC trigger between the de-modulator and the PLC module in parallel. The SNR estimator can calculate the signal to noise ratio (SNR) of the wireless signal in the de-modulator directly. The PLC trigger can calculate the losing condition of the digital signal and make the decision whether proceeds the packet loss concealment (PLC) depend on the condition to make the PLC to the highest efficiency.

To achieve the aforementioned object, the present disclosure provides a signal to noise ratio concealment apparatus in wireless multimedia system comprising: a de-modulator, which includes a SNR estimator; an A/V-decoder, connecting to said de-modulator; a PLC module, connecting to said A/V-decoder; and a PLC trigger, one side connecting to said de-modulator, and the other side connecting to said PLC module.

To achieve the aforementioned object, the present disclosure provides a signal to noise ratio concealment method in wireless multimedia system including a modulator, a de-modulator, a A/V-decoder, a PLC module, a PLC trigger and a gain controller, where the de-modulator includes a SNR estimator, the concealment method comprising the steps of: the modulator transmits a wireless signal to the de-modulator and the de-modulator transforms the wireless signal into a digital signal; the SNR estimator of the de-modulator estimates the signal to noise ratio of the wireless signal and generates a SNR value; the PLC trigger comprehensively analyzes and evaluates the integrity of the digital signal and generates a trigger value; the A/V-decoder transforms the digital signal into a multimedia signal and transmits it to the PLC module; the PLC module makes the decision whether proceeds the packet loss concealment depends on the trigger value; the PLC module conceals the multimedia signal and generates a comprehensively concealed multimedia signal; and the gain controller controls the gain of the multimedia signal or the comprehensively concealed multimedia signal.

In one embodiment of this disclosure, further comprising a gain controller, connecting to said PLC module.

In one embodiment of this disclosure, wherein said PLC trigger further comprising a SNR module.

In one embodiment of this disclosure, wherein said PLC trigger further comprising a header information module.

In one embodiment of this disclosure, wherein said PLC trigger further comprising a CRC module.

In one embodiment of this disclosure, wherein said PLC trigger further comprising a packet information module.

In one embodiment of this disclosure, wherein said PLC module further comprising an interpolator module.

In one embodiment of this disclosure, wherein said PLC module further comprising an extrapolator module.

In one embodiment of this disclosure, wherein said PLC module further comprising a pitch period module.

In one embodiment of this disclosure, wherein said PLC module further comprising a maximum like module.

In one embodiment of this disclosure, wherein said PLC module further comprising a signal character module.

### BRIEF DESCRIPTION OF DRAWINGS

FIG. 1 is a schematic view of a concealment apparatus in wireless multimedia system in prior arts.

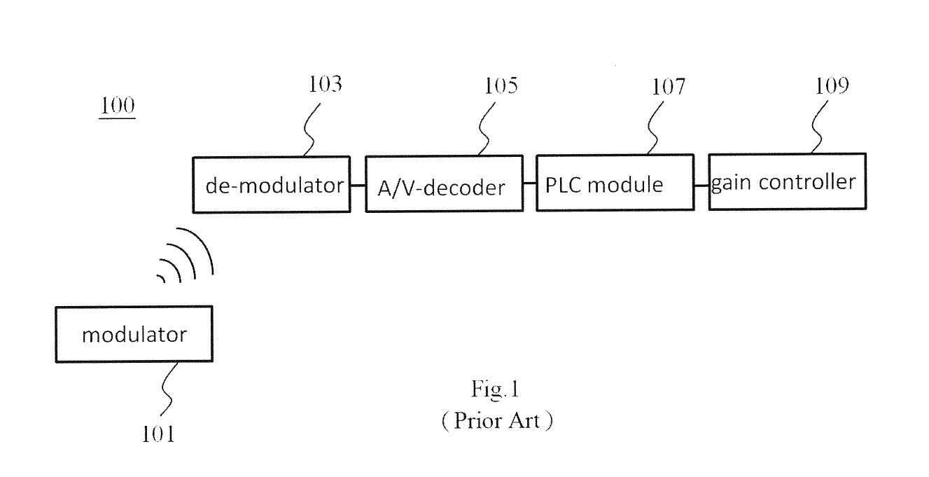

FIG. 2 is a schematic view of a signal to noise ratio concealment apparatus in wireless multimedia system in accordance with an embodiment of the present invention.

FIG. 3 illustrates an example to a waveform of a packet.

FIG. 4 is a flowchart of the signal to noise ratio concealment method of the present invention in wireless multimedia system.

### DETAILED DESCRIPTION OF THE PREFERRED EMBODIMENTS

In order to further understand the present disclosure, preferred embodiments are to be described such that variations and alterations thereto are readily apparent to a person skilled in the art. However, it will be realized that the scope of this disclosure is not confined or restricted to the details of the embodiments described below. Identical reference numerals always designate the same elements throughout all the figures of the drawing.

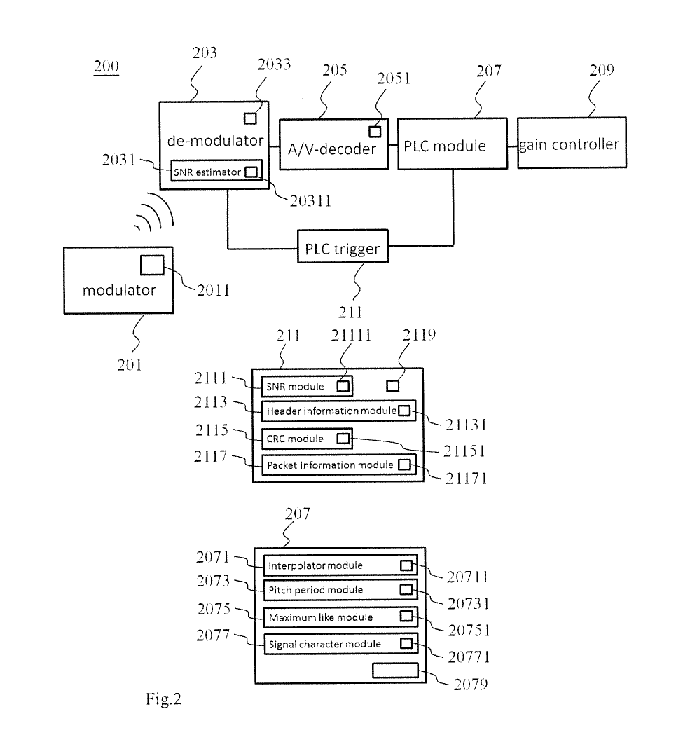

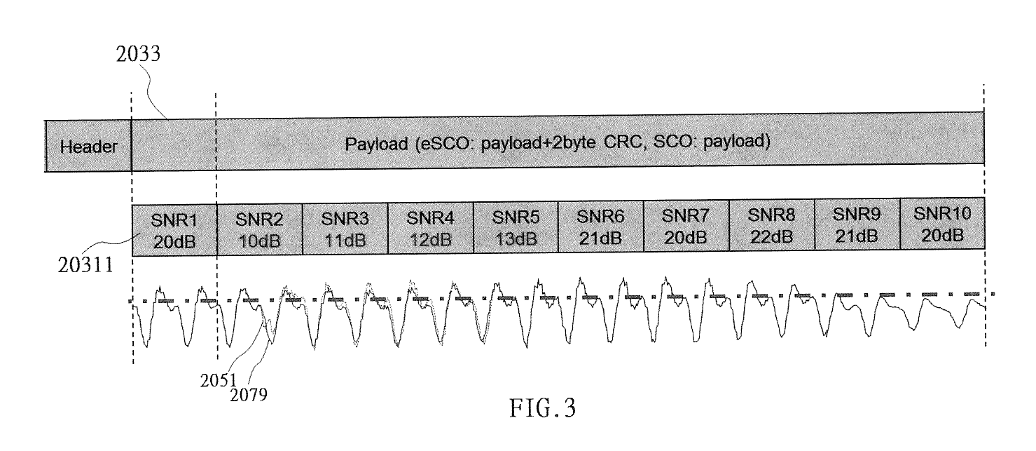

First, referring to FIG. 2 and FIG. 3 there is shown a schematic view of a signal to noise ratio concealment apparatus in wireless multimedia system and an example to a waveform of a packet in accordance with an embodiment of the present invention. As shown, the signal to noise ratio concealment apparatus in wireless multimedia system 200 includes a modulator 201, a de-modulator 203, an AN-decoder 205, a PLC module 207, a gain controller 209 and a PLC trigger 211, said de-modulator 203 includes a SNR estimator 2031, said PLC module 207 includes an interpolator module 2071, a pitch period module 2073, a maximum like module 2075 and a signal character module 2077, said PLC trigger 211 includes a SNR module 2111, a header information module 2113, a CRC module 2115 and a packet information module 2117.

The modulator 201 can transmit a wireless signal 2011 and the de-modulator 203 can receive the wireless signal 2011 and transform it into a digital signal 2033. The SNR estimator 2031 of the de-modulator 203 can estimate the signal to noise ratio of the wireless signal 2011 and generate a SNR value 20311 then transmit the SNR value 20311 to the PLC trigger 211. The SNR module 2111 of said PLC trigger 211 can generate a judgment value 21111 depend on the SNR value 20311. A packet consists of a header and a payload. The properties of the packet are defined in the header, including the communications protocol, source/destination IP and source/destination communication port. Said header information module 2113 can estimate the integrity of the digital signal 2033 and generate a judgment value 21131 depend on the header information of the packets of digital signal 2033. The cyclic redundancy check (CRC) is an error-detecting code used in digital networks to detect accidental changes to signal. Blocks of data entering these systems get a short check value attached, based on the remainder of a polynomial division of their contents. On retrieval the calculation is repeated, and corrective action can be taken against presumed data corruption if the check values do not match. The CRC module 2115 can estimate the integrity of the digital signal 2033 and generate a judgment value 21151 depend on the CRC value of the packets of digital signal 2033. The packet information module 2117 can estimate the integrity of the digital signal 2033 and generate a judgment value 21171 depend on the information of the packets of digital signal 2033. The PLC trigger 211 can comprehensively analyze and evaluate the judgment value 21111, 21131,21151 and 21171 to generate a trigger value 2119 and transmit the trigger value 2119 to the PLC module 207.

The A/V-decoder 205 can transform the digital signal 2033 into a multimedia signal 2051 and transmit it to the PLC module 207.

The PLC module 207 will make the decision whether proceeds the packet loss concealment (PLC) depend on the comprehensively evaluated trigger value 2119. If the PLC module 207 decides not to conceal the multimedia signal 2051 depends on the trigger value 2119. The PLC module 207 will transmit the multimedia signal 2051 to the gain controller 209 and the gain controller 209 can control the gain of the multimedia signal 2051.

If the PLC module 207 decides that the multimedia signal 2051 needs concealment depends on the trigger value 2119. The PLC module 207 can use the interpolator module 2071 to conceal the damaged and/or loss packets of the multimedia signal 2051 by interpolation depend on the previous and/or following intact packets and generate a concealment signal 20711. The pitch period module 2073 can detect the pitch period of the multimedia signal 2051 and repeat the waveform of the primitive period and generate a concealment signal 20731. The maximum like module 2075 uses the pattern matching technique to search and use the previous maximum like intact multimedia waveform concealing the multimedia signal 2051 and generates a concealment signal 20751. The signal character module 2077 conceals the multimedia signal 2051 depends on the signal character like tonal speech and generates a concealment signal 20771. The PLC module 207 will comprehensively analyze the concealment signal 20711, 20731, 20751 and 20771 and generate a comprehensively concealed multimedia signal 2079. And then the PLC module 207 transmits the comprehensively concealed multimedia signal 2079 to the gain controller 209. The gain controller 209 can control the gain of the comprehensively concealed multimedia signal 2079 and make the output video and/or voice more smooth and harmonious. The signal to noise ratio concealment apparatus in wireless multimedia system 200 reduces the affect of the defects and/or loss of the multimedia signal caused by the wireless transport in this way.

Therefore, the present disclosure can accurately estimate the signal to noise ratio of the wireless signal for the calculation in the PLC trigger. It can calculate the SNR, header information, CRC value of the packets more accurately and comprehensively evaluate the information to decide whether proceeds the packet loss concealment by setting the PLC trigger, and make the PLC to the highest efficiency, and improve the usage of the system resource. Also, it can improve the overall effect of the concealment by setting the interpolator module, pitch period module, maximum like module and signal character module in the PLC module and work with the PLC trigger making the overall concealment to the highest efficiency and quality.

In another embodiment of the present invention, the interpolator module 2071 can be replaced by an extrapolator module. The PLC module 207 can use the extrapolator module to conceal the damaged and/or loss packets of the multimedia signal 2051 by extrapolation depend on the previous and/or following intact packets and generate a concealment signal.

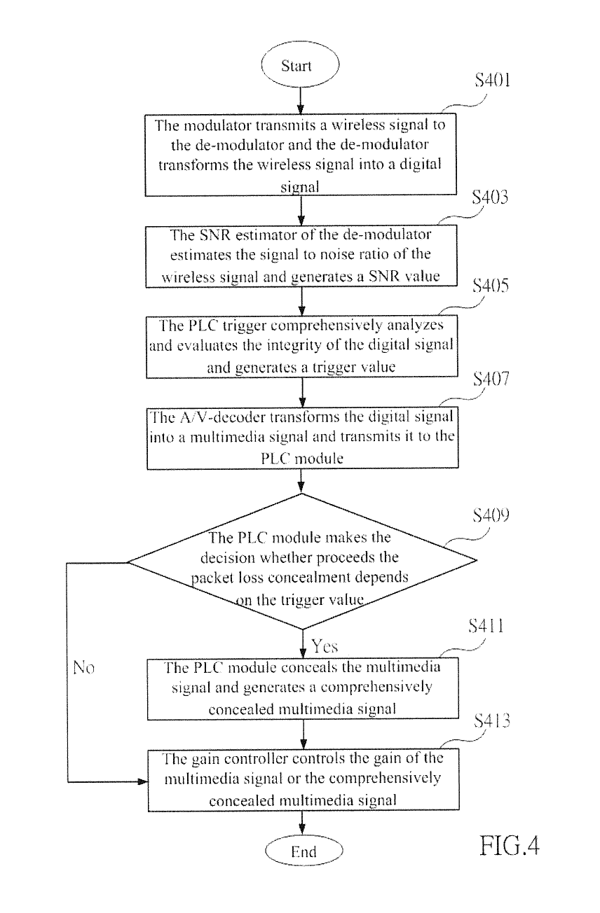

Referring to FIG. 4, there is shown a flowchart of the signal to noise ratio concealment method in wireless multimedia system. In one embodiment, the concealment method includes the following steps. In step 401, the modulator 201 transmits a wireless signal 2011 to the de-modulator 203 and the de-modulator 203 transforms the wireless signal 2011 into a digital signal 2033. In step 403, the SNR estimator 2031 of the de-modulator 203 estimates the signal to noise ratio of the wireless signal 2011 and generates a SNR value 20311. In step 405, the PLC trigger 211 comprehensively analyzes and evaluates the integrity of the digital signal 2033 and generates a trigger value 2119. In step 407, the A/V-decoder 205 transforms the digital signal 2033 into a multimedia signal 2051 and transmits it to the PLC module 207. In step 409, the PLC module 207 makes the decision whether proceeds the packet loss concealment depends on the trigger value 2119. If the PLC module 207 decides not to conceal the multimedia signal 2051, then proceeds to step S413. If the PLC module 207 decides that the multimedia signal 2051 needs concealment, then proceeds to step S411. In step 411, the PLC module 207 conceals the multimedia signal 2051 and generates a comprehensively concealed multimedia signal 2079. In step 413, the gain controller 209 controls the gain of the multimedia signal 2051 or the comprehensively concealed multimedia signal 2079.

The present disclosure, as discussed herein, is industrially applicable, novel, and of significant value in technology development. It is to be understood; however, that this disclosure is not limited to the embodiments set forth and illustrated hereinabove, but encompasses any and all variations falling within the spirit and scope of this disclosure as defined by the appended claims and their equivalents.

1-11. (canceled)

12. A signal to noise ratio (SNR) concealment method configured for a wireless multimedia system, which includes a modulator, a de-modulator, an audio/video (A/V)-decoder, a packet loss concealment (PLC) module, a PLC trigger and a gain controller, where the de-modulator includes a SNR estimator, the concealment method comprising the steps of:
transmitting a wireless signal by the modulator to the de-modulator and transforming the wireless signal into a digital signal by the de-modulator;
estimating the signal to noise ratio of the wireless signal and generating a SNR value by the SNR estimator;
analyzing and evaluating the integrity of the digital signal and generating a trigger value by the PLC trigger;
transforming the digital signal into a multimedia signal and transmitting it to the PLC module by the A/V-decoder;
determining whether to proceed with the packet loss concealment by the PLC module according to the trigger value;
generating a concealed multimedia signal by the PLC module upon determination to proceed with the packet loss concealment; and
controlling a gain of the multimedia signal or the concealed multimedia signal by the gain controller.

13. The signal to noise ratio concealment method of claim 12, further comprising the step of:
generating a judgment value based on the SNR value of the digital signal.

14. The signal to noise ratio concealment method of claim 12, further comprising the step of:
generating a judgment value based on packet header information of the digital signal.

15. The signal to noise ratio concealment method of claim 12, further comprising the step of:
generating a judgment value based on a CRC (cyclic redundancy check) value of packets of the digital signal.

16. The signal to noise ratio concealment method of claim 12, further comprising the step of:
generating a judgment value based on information of packets of the digital signal.

17. The signal to noise ratio concealment method of claim 12, further comprising the step of:
evaluating each of the judgment values by the PLC trigger, in order to evaluate the integrity of the digital signal and generate a trigger value.

18. The signal to noise ratio concealment method of claim 12, further comprising the step of:
generating a concealment signal based on prior and/or subsequent intact packets associated with lost or damaged packets of the multimedia signal.

19. The signal to noise ratio concealment method of claim 12, further comprising the step of:
generating a concealment signal based on detection of a pitch period and primitive waveform of the multimedia signal.

20. The signal to noise ratio concealment method of claim 12, further comprising the step of:
generating a concealment signal based on the previous intact maximum like waveform of the multimedia signal.

21. The signal to noise ratio concealment method of claim 12, further comprising the step of:
generating a concealment signal based on the signal character of the multimedia signal.

22. The signal to noise ratio concealment method of claim 12, further comprising the step of:
analyzing each of the concealment signals by the PLC module in order to generate the concealed multimedia signal.
